(19) United States
(12) Patent Application Publication
(10) Pub. No.: US 2005/0062332 A1
(43) Pub. Date: Mar. 24, 2005

(54) Zinc based material wheel balancing weight

(75) Inventors: Jacques Amyot, Quebec (CA); Georges Usereau, Quebec (CA); Donald Argo, Quebec (CA); Pierre Labelle, Quebec (CA); Martin Lussier, Quebec (CA); Michel Lefebvre, Quebec (CA)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(73) Assignee: NORANDA, INC., TORONTO (CA)

(21) Appl. No.: 10/832,813

(22) Filed: Apr. 26, 2004

Related U.S. Application Data
(62) Division of application No. 10/195,854, filed on Jul. 15, 2002, now abandoned.

(51) Int. Cl. B60B 1/00

(52) U.S. Cl. 301/5.21

(57) ABSTRACT

A wheel balancing weight attached to the rim of a wheel for balancing the wheel is disclosed. The wheel balancing weight comprises a weight mass manufactured from zinc composite or a zinc based material and a means for attaching said weight mass to the rim. The zinc composite or zinc based material wheel balancing weight exhibits physical characteristics in terms of corrosion resistance and ductility comparable to those of traditional lead alloy wheel balancing weights while at the same time providing an environmentally friendly alternative to lead.

### FIELD OF THE INVENTION

The present invention relates to a weight for attachment to the wheel of an automobile for counterbalancing irregularities which would otherwise cause unwanted and potentially dangerous vibrations of the wheel during rotation, especially at high speeds. In particular, the invention relates to a wheel balancing weight fabricated from a zinc based material, including a zinc composite or a zinc alloy, having a very low lead content which exhibits physical characteristics in terms of corrosion resistance and ductility comparable to those of traditional lead alloy wheel balancing weights while at the same time providing an environmentally friendly alternative to lead.

### BACKGROUND OF THE INVENTION

In an automobile wheel assembly including a wheel rim, tire and air inlet valve, there is a potential for a dynamic imbalance in weight to exist when the wheel is rotated. Generally, in order to compensate for this imbalance, the wheel is provided with a wheel balance weight.

The prior art reveals a variety of wheel balancing weights and attachment assemblies for weights manufactured principally from an alloy of lead and approximately 4% of antimony. Lead's physical attributes, including its high molar mass, low melting temperature and the ease with which it can worked, have led to it becoming the primary choice for wheel balancing weights. Lead, however, is toxic and exposed lead can be released into the environment due to leaching or other types of corrosion. As a number of countries, especially in Europe and Asia, are determined to reduce the amount of lead which is released into the environment, alternative materials have been investigated for the fabrication of wheel balancing weights.

The prior art reveals a number of alternative materials which have been proposed and used for the construction of wheel balancing weights, including steel (see, for example, U.S. Pat. No. 6,260,929), ductile cast iron (see, for example, U.S. Pat. No. 6,250,721) and tin (see the PCT application published under WO 99/55924) as well as mixtures of a thermoplastic resin mixed with tungsten powder (see the application for European patent published under EP 1079141 A1) or an ultraviolet curing resin mixed with glass beads (see the PCT application published under WO 99/00609).

However zinc has been rejected for use in wheel weights. For example, PCT application published under WO 99/55924 reports attempts to use zinc for the fabrication of wheel balancing weights. However, it is stated that zinc corrodes easily, that its corrosion resistance can be further impacted negatively by lead contamination, and that zinc lacks the ductility required for the intended purpose. Also there was a perceived need that movement to the production of a zinc wheel weight would required widespread upgrades in order for existing facilities to fabricate wheel balancing weight from zinc. For these reasons, the prior art teaches away from the use of zinc and its use has heretofore not been pursued.

### SUMMARY OF THE INVENTION

The present invention addresses the above and other drawbacks by providing a wheel balancing weight attached to the rim of a wheel for balancing the wheel. The wheel balancing weight comprises a weight mass manufactured from a zinc composite or a zinc based material and a means for attaching said weight mass to the rim. The zinc composite and zinc based materials both have a very low lead content and substantially alleviate the drawbacks associated with the use of lead or zinc having a high lead content.

### BRIEF DESCRIPTION OF THE DRAWINGS

FIG. 1 is a side elevated view of a wheel weight in accordance with an illustrative embodiment of the present invention;

FIG. 2 is a cross-sectional view of a wheel weight in accordance with an illustrative embodiment of the present invention mounted on the rim of a wheel; and

FIG. 3 is a cross-sectional view taken along 3-3 in FIG. 1 of a wheel weight in accordance with an illustrative embodiment of the present invention.

### DETAILED DESCRIPTION OF THE ILLUSTRATIVE EMBODIMENTS

The illustrative embodiments of according to the present invention will now be described.

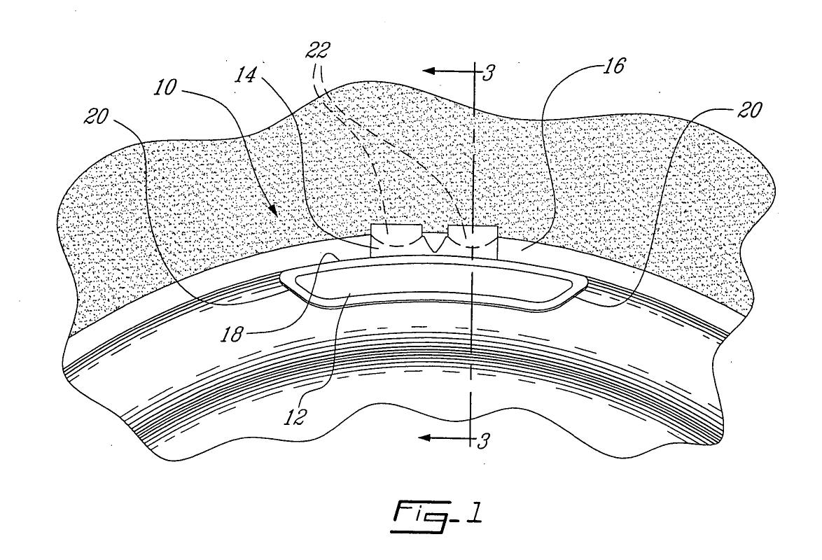

Referring now to FIG. 1, there is illustrated a zinc based material wheel balancing weight generally indicated by the numeral 10. The wheel balancing weight 10 is comprised of a weight body 12 and a mounting clip 14 for attaching the weight body 12 to the flange of a wheel rim 16.

Zinc based materials as used herein includes zinc alloys, where zinc is mixed with other metals to produce an alloy having characteristics comparable to those of lead. Zinc based materials also include zinc based metals which, although not considered alloys in a conventional sense, contain materials (other than lead) that have either been added deliberately to the zinc or are not completely removed from the zinc during refining and that effect the physical characteristics of the zinc metal such that the characteristics are comparable to those of lead.

The weight body 12 is elongate and roughly oval shaped in cross section. The upper edge 18 is slightly curved in order to match the curvature of the wheel rim 16 against which the weight body 12 is snugly held by the mounting clip 14 when in place. The ends 20 of the weight body are tapered towards the upper edge 18. Additionally, the cross sectional area of the weight body 12 diminishes as one moves from the centre of the weight body 12 towards the ends 20. This contributes a low aerodynamic profile to the weight body 12 which in turn reduces the likelihood that wheel weight 10 will attract dirt and other materials or that the wheel balancing weight 10 will be dislodged, for example by the actions of a car wash or when the rim comes into contact with foreign objects such as a curb stones or the like.

The mounting clip 14, which is inserted into the weight body 12 during casting (see FIG. 3), extends above the upper edge 18 of the weight body 12 where it divides into a pair of clip fingers 22. The clip fingers 22 wrap around the flange of the wheel rim 16 and in this manner the wheel rim 16 is securely gripped between the weight body 12 and the pair of clip fingers 22. The mounting clip 14 is typically fabricated from carbon steel, although a variety of steels are potentially useable, including carbon steel, stainless steel, tool steel, spring steel, etc.. In order to reduce the effects of galvanic corrosion which arise when two dissimilar metals are brought into contact in the presence of an electrolyte, the steel clips are preferably coated with an alloy rich in zinc. Note that, although in the present illustrative embodiment the mounting clip 14 is shown with two clip fingers 22, in another embodiment (not shown) a single clip finger for wrapping around the flange of the wheel rim 16 could be provided for.

The weight body 12 is manufactured from a cast zinc alloy comprised of pure zinc with a content of less than 0.006% by weight of lead alloyed with about 4% by weight of aluminium and 0.04% by weight of magnesium, the alloy once cast also known as Zamak 3. Although a variety of zinc based materials such as zinc alloys, including those with the usual/trade names Zamak 2, Zamak 5, Zamak 7, ZA-8, ZA-12 and ZA-27, are also potential metals for use in manufacturing the weight body 12 of the wheel balancing weight 10, the alloy Zamak 3 provides a number of attributes which make it preferable for wheel balancing applications.

Firstly, in many cases existing technology previously used for the fabrication of lead wheel balancing weights can be used to manufacture wheel balancing weights from Zamak 3 with minor modifications.

Additionally, although zinc alloys tend to loose a greater percentage of their weight due to corrosion than do similar lead weights, this loss is negligible. In this regard, two test wheel balancing weights fabricated from Zamak 3 zinc alloy and two test wheel balancing weights fabricated from lead alloy. The weights were painted with a thermoset polyester base powder coating containing about 3% aluminum, although a paint containing up to about 5% zinc could also be used.

The weights were then attached to steel rims and subject to an accelerated corrosion test according to ASTM B117. This test involved exposing the wheel balancing weight/steel rim assemblies to a salt spray at warm temperatures for 100 hours, then cleaning the wheel balance weights according to ASTM G1 to remove any corrosion. Additionally, the painted surfaces of weights Lead #2 and Zinc #2 were scored with a metal scraper to accelerate corrosion of the underlying metal alloys. The results of the test are tabled following:

| | Mass | Mass | | Loss |
|---|---|---|---|---|
| Weight # | (Before) | (After) | Difference | (% weight) |
| Lead #1 | 32.166 g | 32.130 g | 0.036 | 0.11 |
| Lead #2 | 32.943 g | 32.900 g | 0.043 | 0.13 |
| Zinc #1 | 19.471 g | 19.330 g | 0.141 | 0.72 |
| Zinc #2 | 21.348 g | 21.130 g | 0.218 | 1.02 |

As is apparent from the results, Zamak 3 zinc alloy tends to loose a greater percentage of their weight due to corrosion than does the lead alloy. However, the test resulted in a loss due to corrosion on the zinc alloy of typically under 1%, which is still within acceptable limits for the use as a wheel balancing weight.

In any case, the effects of corrosion can be readily reduced by the application of a suitable coating such as paint. For example, coating the outer surfaces of the weight body 12 with a corrosion resistance paint, in particular paint rich in metallic powders of aluminium, zinc or other metals which have an electronegativity similar to the zinc used to fabricate the weight body 12, provide good protection from the effects of corrosion. A paint which is rich in aluminium provides the added benefit of matching the appearance of an aluminium rim, and therefore in some cases can be used to enhance the aesthetic appearance of the wheel balancing weight 10.

Furthermore, although zinc alloys invariably have a tensile strength and hardness greater than that of lead, Zamak 3 is somewhat ductile and allows the cast weight portion of the wheel balancing weight to some degree to be moulded (typically by hammering) to the shape of the wheel rim to which it is being attached. This is important given the variety of diameters of wheels to which the wheel balancing weight might potentially be fastened, even when the intended use of the wheel balancing weight is for a limited range of applications (for example, in the automotive sector, even though a wheel radius of fifteen (15) inches is quite common, wheels of fourteen (14) inches, sixteen (16) inches and up to nineteen (19) inches for use with high performance tires are not uncommon) Therefore the wheel weights can be cast to fit a widely used diameter of wheel, for example a wheel radius of fifteen (15) inches, and then the weight portion adapted by hammering to fit other wheel sizes.

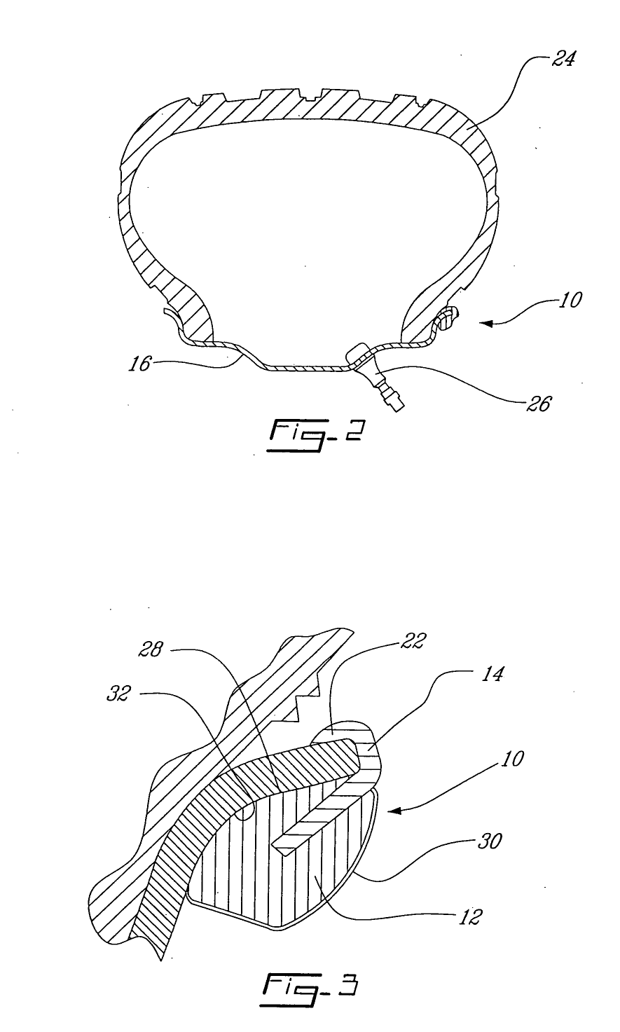

Finally, referring now to FIG. 2, a wheel balance weight 10 is typically installed by first determining the position and mass of the weight necessary to counter any unbalance. In this regard, unbalance can arise due to irregularities in the wheel rim 16, irregularities in the tire 24 (for example, due to uneven wear) or the addition of an air inlet valve 26. A wheel balance weight 10 of the requisite mass is then attached to the flange of the wheel rim 16. Referring now to FIG. 3, the method of installation typically comprises hammering the mounting clip 14 over the flange of the wheel rim 16 such that the flange of the wheel rim 16 is gripped between the clip finger 22 and the inside surface 28 of the weight portion 12. Further hammering of the outer surface 30 of the weight portion 12 serves to drive the weight portion 12 onto the rim surface 32, thereby providing a snug and secure fit as well as adapting to some degree the shape of the weight portion 12 to the curvature of the rim surface 32. The snug fit of the weight body 12 to the wheel rim 16 also provides some added protection against the ingress of water and dirt which can loosen the wheel weight 10.

It is apparent, therefore, that the weight portion 12 of the wheel balance weight 10 must be able to bear the impact of a hammer (not shown) and be flexible to some degree without breaking in order to accommodate a variety of different wheel diameters. Given their relatively low tensile strength and hardness, lead alloys are well adapted to deforming under impact and absorbing shock. In order to assess the suitability of zinc alloys in this regard, a comparative impact test according to ASTM E23 was performed on a series of wheel balance weights wherein the weight portion was manufactured from Zamak 3 zinc alloy or lead alloy. The results of the comparison are tabled following:

| | | Resistance | | | Resistance |
|---|---|---|---|---|---|
| Weight # | Region | Foot/Lbs | Weight # | Region | Foot/Lbs |
| Zinc #1 | Ends | 9.8 | Lead #1 | Ends | 6.2 |
| Zinc #2 | Ends | 7.5 | Lead #2 | Ends | 9.2 |
| Zinc #3 | Ends | 5.2 | Lead #3 | Ends | 8.0 |
| Zinc #4 | Ends | 5.8 | Lead #4 | Ends | 8.4 |
| Zinc #5 | Ends | 6.4 | Lead #5 | Ends | 7.8 |
| Zinc #6 | Ends | 3.3 | Lead #6 | Ends | 9.8 |
| | Mean | 6.3 | | Mean | 8.2 |
| | Variance | 2.2 | | Variance | 1.2 |
| Zinc #7 | Clip | 3.7 | Lead #7 | Clip | 4.3 |
| Zinc #8 | Clip | 3.1 | Lead #8 | Clip | 4.6 |
| Zinc #9 | Clip | 6.1 | Lead #9 | Clip | 3.8 |
| Zinc #10 | Clip | 8.6 | Lead #10 | Clip | 3.5 |
| Zinc #11 | Clip | 5.8 | Lead #11 | Clip | 5.2 |
| | Mean | 5.5 | | Mean | 4.3 |
| | Variance | 2.2 | | Variance | 0.7 |

In the above tables, “Ends” indicates that the impact was in the region away from the centre portion of the wheel balancing weight towards the ends 20 and “Clip” indicates that the impact was in the region towards the centre portion of the wheel balancing weight over the portion where the mounting clip 14 is inserted.

Test results revealed that the Zamak 3 zinc alloy absorbed impact in a manner comparable to the lead alloy. Therefore, notwithstanding its greater tensile strength and hardness, Zamak 3 zinc alloy is generally suited for use in the manufacture of wheel balancing weights.

Although the weight portion 12 of the wheel balancing weight 10 is illustratively cast from a zinc alloy, the weight portion 12 could also be cast from pure zinc or manufactured from a composite including pure zinc or zinc alloy powder combined with a suitable polymeric or silicate binder. Illustratively, the pure zinc or zinc alloy powder would be mixed with the binder and injected into a mould along with the metal mounting clip 14. Once the binder has cured and of sufficient hardness the wheel balancing weight 10 is removed from the mould and on the flange of the wheel rim 16 in a conventional manner as previously described. The pure zinc or zinc alloy powder would constitute about 80% to 90% by weight of the weight portion 12 of the wheel balance weight 10 with 10% to 20% by weight of a suitable binder. In the case of pure zinc powder, which lacks the ductile attributes of a zinc alloy powder, selection of a suitable binder will include one which provides ductility to the weight mass.

The mounting clip 14 used in the above illustrative embodiment is imbedded in the weight portion 12 of the wheel balancing weight 10 during casting of the zinc alloy or curing of the adhesive binder. However, it is within the scope of the present to attach the mounting clip 14 to the weight portion 12 of the wheel balancing weight 10 either by means of an appropriate adhesive, such as a double sided tape, or by provision of grooves or other openings (not shown) in the weight portion 12 into which the mounting clip 14 is inserted.

Additionally, the weight portion 12 of the wheel balancing weight 10 can also be attached to the wheel rim 16 via an adhesive without provision of a mounting clip 14, for example by means of a double sided adhesive tape (not shown). Typically, such wheel balancing weights are relatively flat in cross section and are attached not to the flange of the wheel rim 16 but to an inner surface of the rim, thereby reducing the likelihood that the wheel balancing weight 10 is dislodged due to the centrifugal forces exerted on the wheel balancing weight 10 during wheel rotation. In this regard, those adhesives which are currently used for attaching lead alloy wheel balancing weights would be appropriate for attaching zinc alloy wheel balancing weights.

Although the present invention has been described hereinabove by way of an illustrative embodiment thereof, this embodiment can be modified at will, within the scope of the present invention, without departing from the spirit and nature of the subject of the present invention.

1-36. (cancelled)

37. A method of balancing a wheel, the method comprising:
casting a material selected from one of Zamak 3 and Zamak 7 zinc alloy materials, which includes at least about 0.5% aluminum and less than 0.2% copper, to form a weight mass; and
attaching the weight mass to a rim portion of a wheel.

38-40. (cancelled)

41. The method for balancing a wheel according to claim 1, wherein the attaching step includes:
mechanically coupling the weight mass to a first end of a metal clip; and
mechanically coupling a second end of the metal clip to the rim portion of the wheel.

42. The method for balancing a wheel according to claim 5, wherein the attaching step further includes:
mechanically coupling the weight mass to the first end of the metal clip by inserting the first end of the clip into the weight mass during the casting stage of forming the weight mass.

43-78. (cancelled)
